(19) United States
(12) Patent Application Publication
(10) Pub. No.: US 2006/0186278 A1
(43) Pub. Date: Aug. 24, 2006

(54) Sanitary pipe mounting system

(76) Inventor: James William Tjerrild, Fresno, CA (US)

Correspondence Address: HAYNES BEFFEL & WOLFELD LLP, P O BOX 366, HALF MOON BAY, CA, 94019, US

(21) Appl. No.: 11/053,216

(22) Filed: Feb. 8, 2005

(51) Int. Cl. F16L 3/08

(52) U.S. Cl. 248/65

(57) ABSTRACT

Have invented a new strut system designed for the attachment of pipes, conduit, and tubes to vertical and horizontal surfaces in a sanitary manner. The mounting of pipes, conduits or tubes in an environment that demands a high level of sanitation, (i.e.; food processing and pharmaceutical manufacturing) is best accomplished through the use of my invention. Unlike strut systems currently available, my strut system repels contaminants, is easy to inspect, and easy to clean.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

My invention is intended to be used in food processing and pharmaceutical processing facilities to improve the inspectability and cleanability of pipe, conduit, and tube installations. Currently, these facilities are forced to use standard mounting systems to install pipe, conduit, and tube. The standard mounting systems are inherently dirty. Also, the standard mounting systems are exceedingly difficult to inspect and clean.

### BRIEF SUMMARY OF THE INVENTION

My invention is a new sanitary system for mounting pipe, conduit, and tube in food grade or pharmaceutical grade installations. It is designed such that it resists contamination, is easy to inspect, and easy to clean.

### BRIEF DESCRIPTION OF THE SEVERAL VIEWS OF THE DRAWING(S)

1A. Top view of wall mount strut assembly

1B. Side view of wall mount strut assembly

1C. Front view of wall mount strut assembly

1D. Exploded isometric assembly of wall mount strut application

2A. Top view of trapeze mount strut assembly

2B. Side view of trapeze mount strut assembly

2C. Front view of trapeze mount strut assembly

2D. Exploded isometric assembly of trapeze mount strut application

3A. Top view of spacer

3B. Front view of spacer

4A. Top view of wall mount strut

4B. Front view of wall mount strut

4C. End view of wall mount strut

5A. Top view of trapeze mount strut

5B. Front view of trapeze mount strut

5C. End view of trapeze mount strut

6A. Top view of “L”-bracket

6B. Front view of “L”-bracket

6C. Side view of “L”-bracket

7A. End view of hanger rod

7B. Front view of hanger rod

### DETAILED DESCRIPTION OF THE INVENTION

My invention is a mounting system that sanitarily mounts pipes, conduits, and tubes to vertical and horizontal surfaces in locations that require a high degree of cleanliness. Typically, this mounting system would be employed in food processing and pharmaceutical factories.

In the past, these facilities have had only standard strut systems to mount their pipes, conduit, and tubes. This has been a major food and drug safety problem, as standard strut systems are easily soiled, harbor contaminants, are difficult to inspect, and difficult to clean.

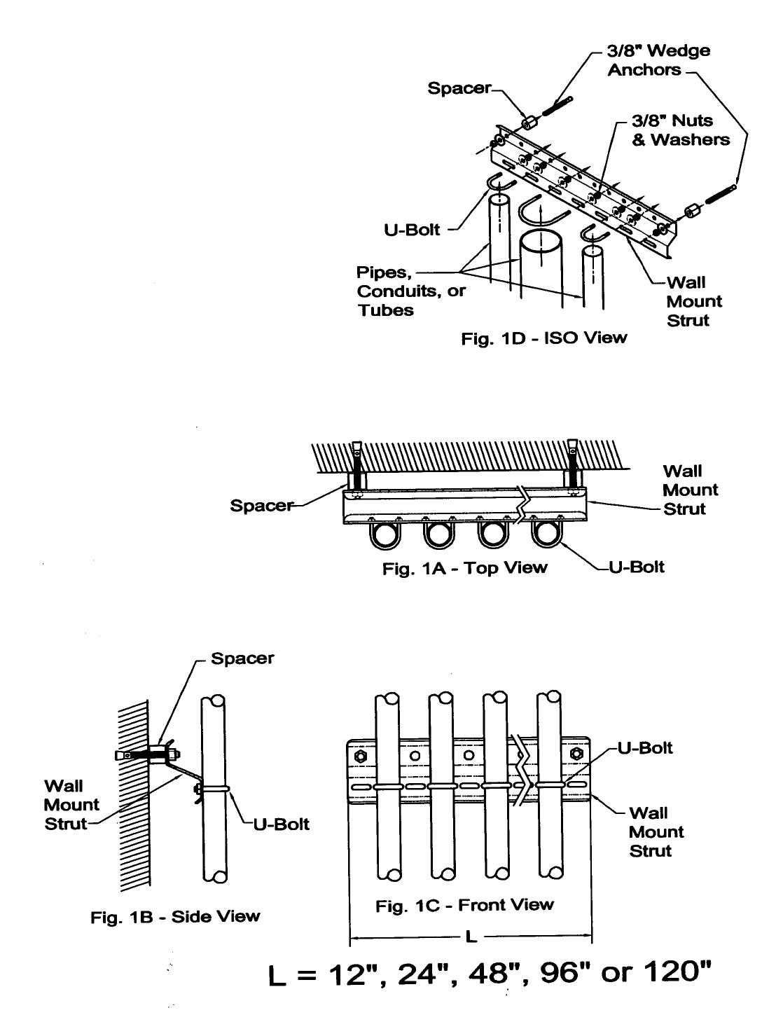

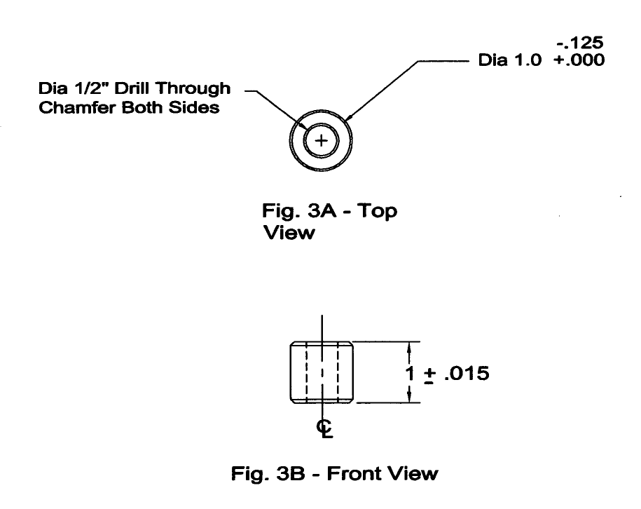

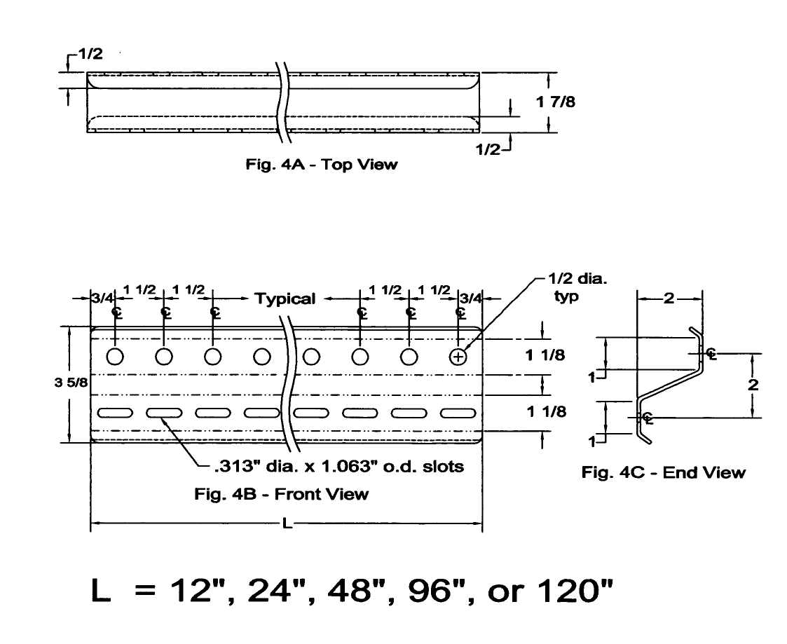

My sanitary strut system can be configured for two general applications. When mounting pipes, conduits, or tubes to a wall (or other vertical surface), the “wall mount” strut assembly (shown in FIGS. 1A, 1B, 1C, and 1D) is preferred. The main components of this assembly are “wall mount strut” (shown in FIGS. 4A, 4B, and 4C) and multiple “spacers” (shown in FIGS. 3A and 3B). The wall mount strut is punched and cold formed from 12 gauge T304 stainless steel sheet that is polished to a #4 sanitary finish. The multiple punched holes and slots permit mounting of the strut to the wall and pipes to the strut in multiple locations. Specifically, note that the strut's cross section has no horizontal surfaces (see FIG. 1B). Standard struts typically have multiple horizontal surfaces. My strut's configuration is better than standard strut, in that is tends to “shed” falling contaminants downward, as opposed to collecting them. The wall mount spacers are machined from solid 1″ diameter T304 stainless steel round bar. Specifically, note that the spacers hold the strut away from the wall at a distance of not less than 1″ (see FIG. 1A). Standard strut systems typically mount the strut directly to the wall. My strut system is better than standard systems in that this gap between the wall and the back of the strut facilitates inspection, cleaning, and allows falling contaminants and water from wash downs to fall through this gap and downward. Conversely, the back surface of standard strut mounted directly to the wall is not inspectable, cleanable, and harbors filth and mildew. The pipes, conduits, or tubes are attached to the wall mount strut with stainless steel U-bolts of minimum thread length, as threads are difficult to clean. The entire assembly is attached to the wall with ⅜″ diameter stainless steel wedge anchors (see FIG. 1D).

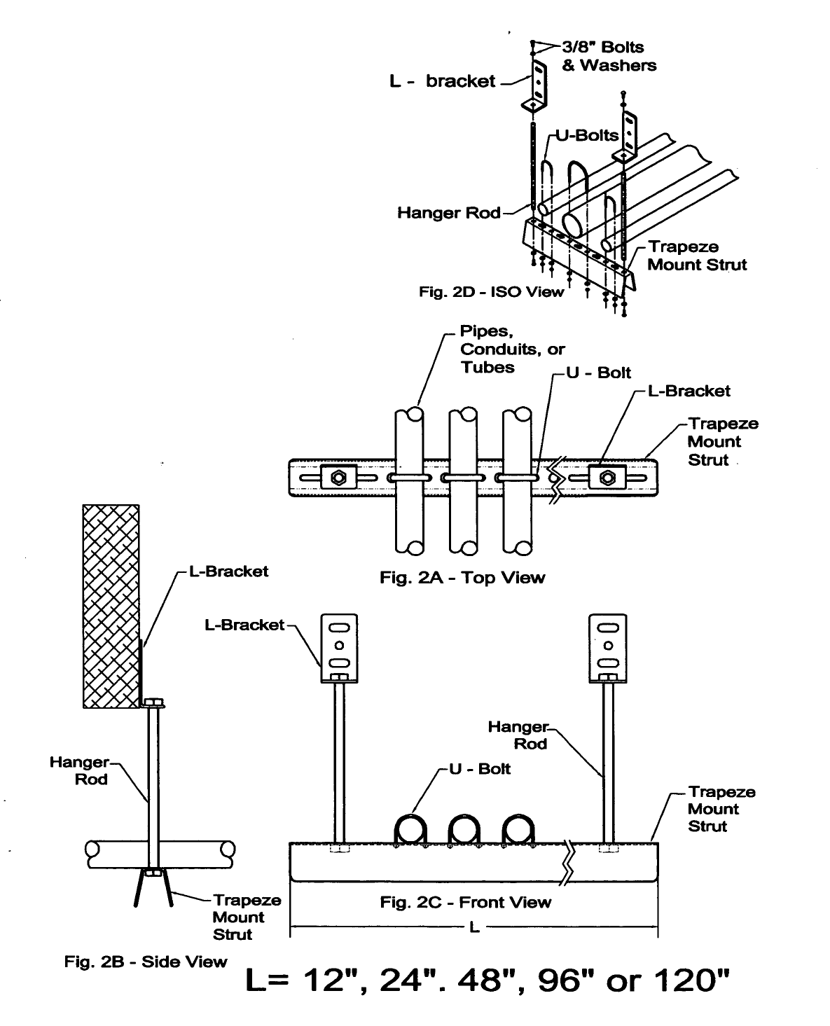

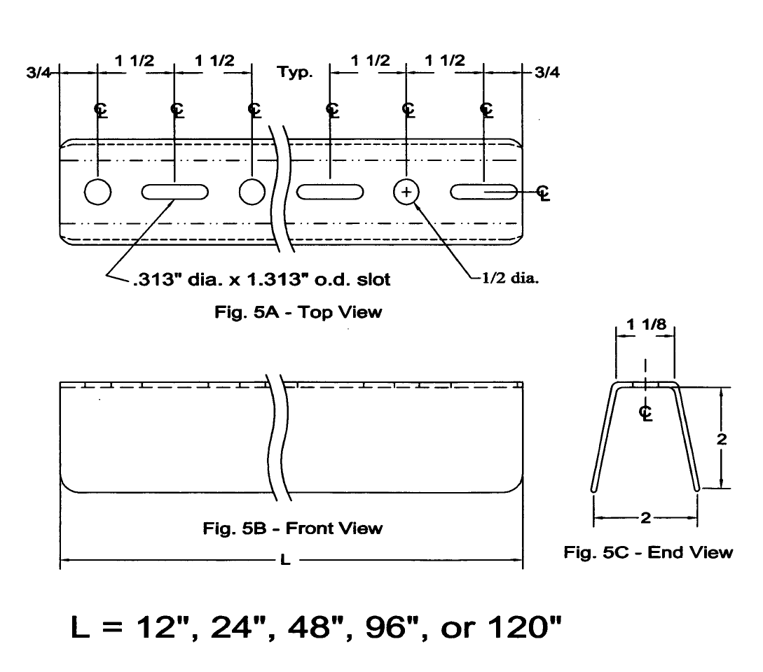

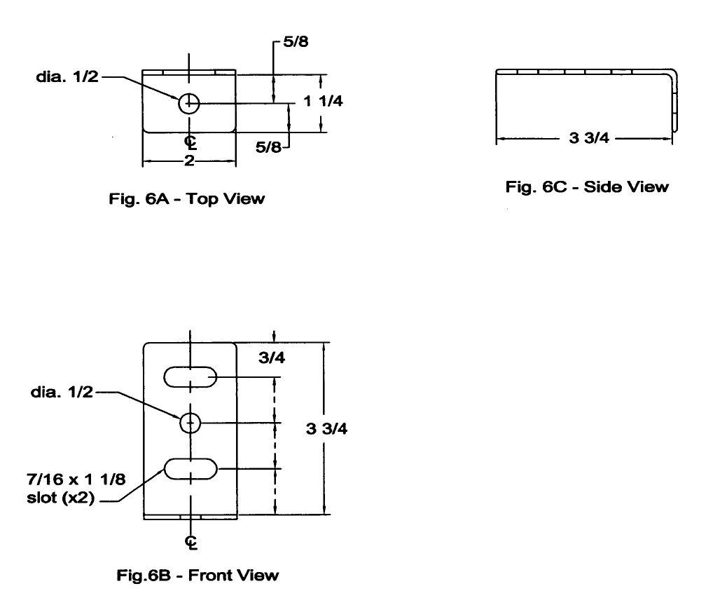

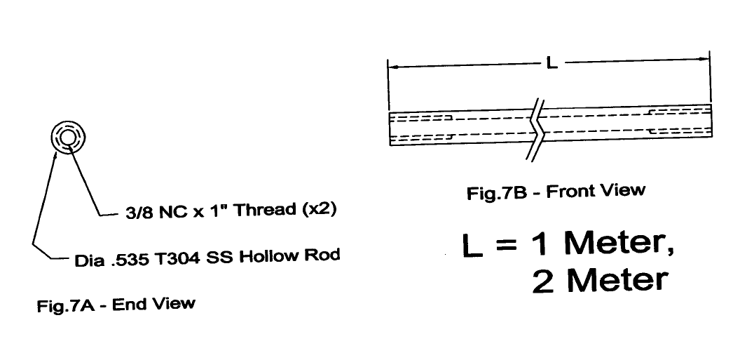

To mount pipes, conduits, or tubes below a ceiling (or other horizontal surfaces), the “trapeze mount strut” assembly (shown in FIGS. 2A, 2B, 2C, and 2D) is preferred. The main components of this assembly are “trapeze mount strut” (shown in FIGS. 5A, 5B, and 5C) and smooth hanger rods (shown in FIGS. 7A and 7B). The trapeze mount strut is punched and cold formed from 12 gauge T304 stainless steel sheet that is polished to a #4 sanitary finish. The multiple punched holes and slots permit mounting of strut to ceiling and pipes to strut in multiple locations. Specifically, note that my strut is an “open” C-channel with legs pointing downward (see FIG. 2B). Standard trapeze struts are “closed” C-channels with hemmed legs that point upward. My strut system is better than standard strut systems, in that the legs of my trapeze mount strut are open, not hemmed, and point downward, thus allowing easy inspection, cleaning, and eliminates any upward facing troughs to collect and hold contaminants. Conversely, standard trapeze mount installations have upward facing channels that trough to hold falling debris, and wash down water. Their design is so enclosed as to require disassembly for cleaning in some cases to achieve an adequate level of sanitation. The smooth hanger rods are fabricated from T304 stainless steel schedule 80 pipe. They are tapped in each end for ⅜″ national coarse threads, and the outer surface is polished to a #4 sanitary finish (see FIGS. 7A and 7B). Standard trapeze struts are mounted with continuously threaded rod. My trapeze strut system is better, as the smooth hanger rods are easy to clean, where as the outer surface of the standard strut's continuously threaded rods is so convoluted, that they are extremely difficult to satisfactorily clean. The pipes, conduits and tube are attached to the trapeze mount strut with the same stainless steel minimum thread U-bolts used for wall mount strut, and the entire trapeze assembly is attached to the ceiling with L-brackets (see FIGS. 6A, 6B, and 6C).

Overall, my stainless steel strut system provides a means by which one can attach pipes, conduits, and tubes to horizontal and vertical surfaces in a sanitary way. This level of inspectability and cleanability is not provided by the struts currently on the market.

1. My sanitary strut system eliminates unnecessary horizontal surfaces that collect and harbor contaminants.

2. My sanitary strut system eliminates upward facing channels that collect and harbor contaminants.

3. (canceled)

4. (canceled)

5. (canceled)
